(19) United States
(12) Patent Application Publication
(10) Pub. No.: US 2002/0090325 A1
(43) Pub. Date: Jul. 11, 2002

(54) Apparatus and method for producing carbon black, and furnace combustion apparatus and furnace combustion method

(76) Inventors: Toshiaki Hasegawa, Yokohama-shi (JP); Yoshio Watanabe, Yokohama-shi (JP); Yutaka Fukuyama, Yokkaichi-shi (JP); Tatsuhiko Yamazawa, Kitakyushu-shi (JP); Hiroaki Takehara, Kitakyushu-shi (JP); Takaharu Yamamoto, Kitakyushu-shi (JP)

Correspondence Address: NIXON & VANDERHYE P.C., 8th Floor, 1100 North Glebe Rd., Arlington, VA, 22201-4714, US

(21) Appl. No.: 09/991,874

(22) Filed: Nov. 26, 2001

Related U.S. Application Data
(63) Continuation of application No. PCT/JP01/02560, filed on Mar. 28, 2001.

(30) Foreign Application Priority Data
Mar. 29, 2000 (JP) 2000-91726

(51) Int. Cl. B01J 8/04; C09C 1/48

(52) U.S. Cl. 422/188; 423/449.1; 423/450; 422/193; 422/189

(57) ABSTRACT

A carbon black producing apparatus comprising a first reaction zone (1) where an oxygen-containing gas and fuel are supplied into the reactor and burned to form a combustion gas flow, a second reaction zone (2) disposed downstream of the first reaction zone and having a feedstock hydrocarbon feed port or ports for supplying a feedstock hydrocarbon to the combustion gas flow, whereby the feedstock hydrocarbon is reacted to produce carbon black, and a third reaction zone (3) disposed downstream of the second reaction zone and designed to stop the reaction, wherein in the first reaction zone, fuel feed port(s) (5) and oxygen-containing gas feed port(s) (6) are provided independently spaced-apart from each other and opened into the reactor from the same side thereof. According to such a carbon black producing apparatus, in carrying out efficient production of carbon black of smaller particle size with narrower agglomerate diameter distribution, it is possible to restrain damage to the reactor wall refractory in the combustion section, to effect perfect combustion of the fuel at as high a temperature as possible and an air ratio close to 1, and to suppress discharge of NOx.

### TECHNICAL FIELD

The present invention relates to an apparatus and a method for producing carbon black, and to a furnace combustion apparatus and a furnace combustion method.

### BACKGROUND ART

Carbon black has been widely used long since for printing ink, paint pigment, fillers, reinforcing additives, weather resistance improver and the like in accordance with its various properties such as surface area, particle size, oil absorption, structure, pH, blackness, coloring power and hardness. For example, carbon black used as coloring agent in resin colorants, printing inks and paints is required to excel in blackness, dispersibility, grossness and coloring power, while carbon black used as rubber composition reinforcement for automobile tires is required to have excellent wear resistance.

Carbon black is usually composed of primary particles and their agglomerates, and the properties of carbon black are subject to the influence of such particles and agglomerates. For example, it is known that blackness and coloring power have large dependency on primary particle size of carbon black, with blackness elevating as the primary particle size lessens, as disclosed in Japanese Patent Application Laid-Open (KOKAI) No. 50-68992, etc. It is also known that when such carbon black is used as tire reinforcement, the tire shows high wear resistance. It is further known that higher blackness and better dispersibility are provided as the size of carbon black agglomerates lessens and the primary particle and agglomerate size distribution narrows.

As the carbon black production method, there are known furnace method, channel method, thermal method, acetylene method, etc., among which furnace method can be cited as the ordinary production method. According to this method, for instance a cylindrical carbon black producing apparatus (reactor) is used, and an oxygen-containing gas such as air and fuel are supplied into a first reaction zone of the reactor either horizontally or vertically to the axis of the reactor and burned, with the resulting combustion gas flow being transferred into a second reaction zone having a reduced sectional area, which is disposed downstream in the axial direction of the reactor, and a feedstock hydrocarbon (feedstock oil) is supplied into the said gas flow and reacted to produce carbon black. The gas flow is further led into a third reaction zone located downstream of the second reaction zone, and is quickly cooled by spray of cooling water or other means to stop the reaction.

More specifically, the feedstock hydrocarbon is supplied into the gas flow in the second reaction zone, this liquid hydrocarbon being atomized by dint of movement of the gas and heat energy, and if necessary a choke is provided in the second reaction zone to generate turbulence of the gas flow in front and in the rear of the choke, which expedites mixing and allows efficient utilization of heat energy of combustion gas for the carbon black producing reaction. It is considered that carbon black is produced in the following way. The feedstock hydrocarbon is thermally decomposed on contact with the combustion gas flow and then condensed into liquid droplets to form a nucleus precursor, thus generating primary particles. Such primary particles impinge against each other to be fused together and carbonized to produce carbon black (agglomerates).

For obtaining carbon black of small particle size by, for instance, the above-mentioned furnace method, it is known to lessen the amount of feedstock hydrocarbon to be injected into the combustion gas flow. However, as a matter of course, lessening of the injected amount of hydrocarbon leads to a reduction of productivity of carbon black. So, as a method for obtaining carbon black of small particle size without reducing productivity, a method has been used in which the gas temperature of the feedstock hydrocarbon injected area is raised for enabling efficient production of the objective material.

In the production of carbon black, formation of the said primary particles is expedited by high temperature and the size of the produced primary particles is lessened. Also, since the carbonization rate is also raised, the time required till the primary particles are agglomerated and massed after impinging against each other is shortened, and the agglomerates also become smaller. Therefore, for effecting uniform gasification and thermal decomposition of the feedstock hydrocarbon and for obtaining carbon black of small particle size, it is important to place the second reaction zone under a sufficient degree of high temperature atmosphere.

In the above operation, it is also important to minimize the oxygen concentration in the combustion gas. This is for the reason that in the furnace method, only part of the feedstock hydrocarbon may be burned (partial combustion) to reduce the yield, so that the oxygen concentration in the combustion gas is kept low at around 1 to 5% to inhibit partial combustion. That is, the lower the oxygen concentration is, the less the concentration of carbon monoxide (CO) in the final exhaust gas becomes. That the CO concentration lessens means that the formation rate of carbon dioxide (CO₂) in the combustion reaction elevates, i.e., the calorific value in the combustion reaction increases to realize a rise of combustion gas temperature.

The reaction where superfluous oxygen becomes CO₂ is expressed as C+O₂→CO₂, and the reaction where CO is formed is expressed as 2C+O₂→2CO. As is apparent from these formulae. carbon consumption is doubled when CO is formed. It is, therefore, possible to greatly improve the yield by lessening the residual oxygen concentration in the combustion gas and reducing CO produced.

As described above, in the carbon black producing reaction, when the oxygen concentration is low, partial combustion of the feedstock hydrocarbon is curbed, so that the yield is improved and the atmosphere of the carbon black produced region is kept uniform, making it possible to obtain carbon black having a narrow distribution of primary particle and agglomerate size. The upshot is that in the production of carbon black, elevation of gas temperature at the feedstock hydrocarbon feed position leads to high-yield production of high-quality carbon black which is small in size and has a narrow distribution of particle size and agglomerate size, without reducing productivity.

Elevation of gas temperature in the feedstock hydrocarbon injected area can be effectuated by conducting combustion of higher temperature in the combustion section, which is the first reaction zone. As means therefor, a method using oxygen-enriched air as combustion air is well known. However, when combustion is conducted by a conventional method, adiabatic flame temperature of the combustion section becomes by far higher than gas temperature of the feedstock hydrocarbon injected area. For example, when it is tried to maintain temperature of the feedstock hydrocarbon injected area at 1800° C. or higher, adiabatic flame temperature of the combustion section becomes 2,100° C. or higher, which damages the refractory constituting the furnace to make it unable to carry on the stable continuous operation.

Also, when the air ratio of the first reaction zone is made approximately 1 by lowering the oxygen concentration, so-called “soot” tends to be generated in the combustion section, giving rise to the problem that the particle size distribution of the product carbon black scatters to degrade the product quality. (Here, “air ratio” is the ratio of the actually supplied amount of air to the theoretical amount of burned air in the supplied fuel.) Further, when combustion temperature is elevated, concentration of nitrogen oxide (hereinafter referred to as “NOx”) in the exhaust gas also rises to produce the environmentally unfavorable problems.

On the other hand, regarding the combustion method itself, there is known a so-called high-temperature air combustion method according to which, in an ordinary industrial heating furnace, an oxidative exothermic reaction is carried out at a sufficiently low heat generating rate as compared with ordinary combustion, with the generation of NOx being restrained by bringing the average heat flux close to the maximum heat flux.

For example, in Japanese Patent Application Laid-Open (KOKAI) No. 10-38215 is disclosed a burner combustion method in which the oxygen concentration is far lower than ordinary air at least immediately before the combustion reaction, and diffusion combustion is conducted under a sufficiently low-rate oxidative exothermic reaction with dilute air of high temperature, which is higher than the combustion stability limit temperature of the gas mixture at the said oxygen concentration, or an equivalent oxidative agent. More specifically, as illustrated in the accompanying drawings, there is used a cross-flow system in which after high-temperature air has been diluted with nitrogen, fuel jet dashes into the high-temperature preheated air flow from a direction perpendicular thereto. And it is described that if the dilute air, or an oxidative agent for combustion, is of high temperature, combustion can be effected even if oxygen concentration is lowered.

Further, it was found that when oxygen concentration as an oxidative agent for combustion is made far lower than that of ordinary air while raising the temperature of combustion air far above that used in the conventional exhaust gas recirculation combustion method without changing air ratio, there takes place stabilized combustion when oxygen concentration comes to meet a certain condition, even though the oxidative exothermic reaction is very slow as compared with the case using ordinary air, and in such a case, as there occurs an increase of the ratio of combustion reaction intermediate product in the hydrocarbon type fuel which yields a green spectral component in the visible luminescent colors of the flames, the flames become greenish rather than bluish in ordinary combustion (greening).

However, in the above patent application is silent on the method of producing carbon black, and as means for inducing high-temperature air combustion, there is used a method in which combustion is induced by using an oxidizing agent which has been preheated to a high temperature of around 1000° C. and diluted. Here, as a method for preheating air to be supplied into the reactor to a high temperature, there is known a method using so-called regenerative burners. Specifically, this is a method in which air supplied into the reactor is preheated by a heat accumulator by conducting supply of air and suction of exhaust gas repeatedly by turns with a pair of burners incorporated with a heat accumulator. As means for diluting oxygen concentration, methods are known in which, for example, exhaust gas is recirculated or diluted with an inert gas such as nitrogen. In the above patent application, high-temperature air is used after diluting it with nitrogen.

But in the method such as mentioned above, namely in the combustion method in which air supply and suction of exhaust gas are conducted alternately as means for obtaining high-temperature preheated air, the local combustion gas temperature varies with time. Therefore, when such a method is applied to a carbon black producing furnace, production of carbon black with stabilized quality may become difficult. Also, the method in which exhaust gas is recirculated or diluted with an inert gas such as nitrogen as means for diluting oxygen concentration requires extra cost for equipment and is therefore unfavorable for application to a carbon black producing furnace.

Further, in the paragraph [0026] of the above-mentioned Japanese Patent Application Laid-Open (KOKAI) No. 10-38215, as one of the means for easily and economically supplying high-temperature dilute air which has been heated to a predetermined temperature and diluted to a predetermined oxygen concentration and an oxidizing agent, there is shown a method in which high-temperature air is injected into the furnace at high speed to entrain furnace exhaust gas and oxygen concentration is diluted before air is contacted with fuel. However, here is only described a method for diluting high-temperature air, and no mention is made of heating air to a high temperature of around 1,000° C. Also, as apparent from the statement at paragraph [0027] of the above patent application: “It is impossible to estimate or calculate how much exhaust gas will be entrained by high-speed air jet, and it is difficult to set the oxygen concentration and temperature of dilute air just before the combustion reaction at the predetermined values,” it is very difficult to induce high-temperature air combustion by the so-called furnace fuel direct injection method with mere setting of the furnace or burners. As mentioned above, furnace fuel direct injection method is known as another combustion method capable of controlling generation of NOx in the industrial heating furnaces. More specifically, this is a method in which combustion air and fuel are injected into the furnace from the individual nozzles, and the surrounding combustion gas is sucked in by the exhaust gas self recirculating effect produced by the injection energy to thereby effectuate a reduction of oxygen concentration of combustion air and a drop of flame temperature during combustion.

As the said furnace fuel direct injection method, Japanese Patent No. 2,683,545 discloses a furnace combustion method in which the air feed port(s) and the fuel feed port(s) are provided independently spaced-apart from each other and opened into the furnace in the same direction, with each air feed port being disposed with a distance of not less than 1.5 times its opening diameter from the furnace wall.

The above patent application, however, only describes a furnace combustion method which controls the generation of NOx by lowering the flame temperature in an industrial heating furnace, and is silent on the method in which combustion is effected at as high a temperature as possible and an air rate close to 1 without causing any damage to the furnace refractory. Also, regarding use of the furnace, this patent application merely mentions glass melting furnace, and makes no mention of carbon black producing furnace.

At column 5 of the above patent application, it states: “Since an object to be heated (steel material, molten metal, etc.), which is lower in temperature than the surrounding furnace wall, is present in the furnace, there takes place radiative heat transfer to the said low-temperature object at the same time with generation of NOx in the furnace space, so that an effect of lowering NOx generation level can be obtained from this aspect, too.” Thus, it has been considered that lowering of flame temperature was undesirable in the production process of carbon black as it was important, for the betterment of efficiency, to effect combustion of the feedstock hydrocarbon at as high a temperature as possible in the production of carbon black.

In the furnace direct injection method such as presented in the above patent application, although it is described to control generation of NOx by lowering flame temperature, no mention is made of high-temperature air combustion, and as regards combustion temperature in the furnace, as far as we can see from its Examples, it is as low as only around 1,500° C. Thus, in the above patent application, only low temperatures of from self ignition temperature of fuel (around 900° C. when using natural gas as fuel) up to around 1,500° C. are available.

In order to solve the above problem, there has been proposed a combination of the furnace fuel direct injection method with so-called regenerative burners in which in order to make combustion air temperature higher than self ignition temperature of fuel, air is preheated by the heat accumulated in a heat accumulator before air is supplied into the furnace.

However, in the above method, i.e., in the combustion method comprising alternate operations of air supply and exhaust gas suction, local combustion gas temperature varies with time as mentioned before. Therefore, when such a method is applied to the carbon black producing furnace, it may prove difficult to produce carbon black of stabilized quality.

On the other hand, a carbon black producing method in which oxygen-containing gas and fuel are supplied independently into the reactor is described in Japanese Patent Publication (KOKOKU) No. 31-2167. This patent publication, however, concerns a method of producing carbon black (oil black) using liquid hydrocarbon, which is an inexpensive material, by remodeling the producing furnace (reactor) of carbon black (gas black) using costly gaseous hydrocarbon as feedstock, and this publication is silent on the carbon black production method in which combustion is conducted at as high a temperature as possible and an air ratio close to 1 while suppressing NOx discharge without damaging the reactor and the refractory material composing its wall. Further, in the combustion method described in the above patent publication, the exhaust gas self recirculating effect, which is the greatest feature of the furnace fuel direct injection method, is not produced because of small spacing between the feed ports of oxygen-containing gas and fuel.

As viewed above, it has been a subject for research in the art to develop an apparatus and a method for producing carbon black of smaller particle size and narrower agglomerate size distribution by conducting perfect combustion of fuel at as high a temperature as possible and an air ratio close to 1 while restraining damage to the reactor wall refractory in the combustion section.

### BRIEF DESCRIPTION OF THE DRAWINGS

FIG. 1 is a general schematic sectional view of an example of carbon black producing apparatus according to the present invention.

FIG. 2 is dispositional illustrations of oxygen-containing gas introductions nozzles and fuel introduction nozzles.

FIG. 3 is a partial schematic sectional view of an example of carbon black producing apparatus according to the present invention.

FIG. 4 is a partial schematic sectional view of another example of carbon black producing apparatus according to the present invention (and a partial schematic sectional view of an example of furnace combustion apparatus according to the present invention).

FIG. 5 is a schematic illustration of a conventional carbon black producing furnace.

FIG. 6 is a schematic dimensional illustration of a conventional carbon black producing furnace.

FIG. 7 is a supplementary drawing for calculating the maximum frequency Stokes equivalent diameter (Dmod) and the Stokes equivalent diameter half-value width (D½).

FIG. 8 is a supplementary drawing for calculating the 75%-volume diameter (D75).

### DISCLOSURE OF THE INVENTION

As a consequence of many studies on the optimal furnace structure of the combustion section for the production of carbon black, the present inventors have found that by adopting a furnace structure in which an air feed port or ports and a fuel feed port or ports are disposed independently spaced-apart from each other in the first reaction zone and opened into the furnace (reactor) in the same direction, so that combustion air and fuel will be injected individually into the furnace from the said air feed port(s) and fuel feed port(s), respectively, and burned in the furnace, it is possible to eliminate only the non-uniformity of temperature distribution without lowering combustion temperature in the first reaction zone, that is, flattening of the distribution of combustion condition is promoted by lowering the peak temperature of combustion, and it becomes possible to effectuate perfect combustion with stability at a high temperature of not lower than 2,000° C. and an air ratio close to 1 with low discharge of NOx, without damaging refractory of the reactor interior structure. The present inventors also have found that it is possible to control the combustion condition by providing a structure in which an additional fuel feed port is provided in each said air feed port, and by controlling the ratio of the fuel supplied from the said fuel feed port(s) to the fuel supplied from the said additional fuel feed port(s) in the air feed port(s).

The apparatus and method for producing carbon black according to the present invention combine advantages of both the high-temperature air combustion method and the in-furnace direct fuel injection method for combustion in the combustion section, and realize so-called high-temperature air combustion in which combustion is effected only by independent supply of air and fuel into the furnace (reactor) without using any change-over type devices such as regenerative burners, and the air temperature is made higher than the self ignition temperature of fuel and also oxygen concentration is lowered before combustion air is joined with fuel. The essential points of the above-said apparatus and method of the present invention are as described in (1) to (4) below.

(1) A carbon black producing apparatus comprising a first reaction zone where an oxygen-containing gas and fuel are supplied into the reactor and burned to form a combustion gas flow, a second reaction zone disposed downstream of the first reaction zone and having a feedstock hydrocarbon feed port or ports for supplying a feedstock hydrocarbon to the combustion gas flow for reacting said hydrocarbon to produce carbon black, and a third reaction zone disposed downstream of the second reaction zone and designed so that the reaction will stop in this third reaction zone,

in the first reaction zone, the fuel feed port(s) and the oxygen-containing feed port(s) being provided independently spaced-apart from each other and being opened into the reactor from the same side thereof.

(2) A method for producing carbon black, characterized in that the above-described apparatus is used.

(3) A method of producing carbon black comprising using a carbon black producing apparatus which comprises a first reaction zone where an oxygen-containing gas and fuel are supplied into the reactor and burned to form a combustion gas flow, a second reaction zone disposed downstream of the first reaction zone and having a feedstock hydrocarbon feed port or ports for supplying a feedstock hydrocarbon to the combustion gas flow for reacting said hydrocarbon to produce carbon black, and a third reaction zone disposed downstream of the second reaction zone and designed so that the reaction will stop in this third reaction zone,

in the first reaction zone, the combustion gas flow being formed by high-temperature air combustion.

(4) A method of producing carbon black comprising using a carbon black producing apparatus having a first reaction zone where fuel and an oxygen-containing gas are supplied into the reactor from a fuel feed port or ports and an oxygen-containing gas feed port or ports provided independently spaced-apart from each other to open into the reactor, a second reaction zone disposed downstream of the first reaction zone and having a feedstock hydrocarbon feed port or ports for supplying a feedstock hydrocarbon to the combustion gas flow for reacting said hydrocarbon to produce carbon black, and a third reaction zone disposed downstream of the second reaction zone and designed so that the reaction will stop in this third reaction zone,

the average temperature of the first reaction zone is not lower than the ignition temperature of the fuel, and combustion being conducted while forming a recirculating flow between the oxygen-containing gas feed flow and the inner wall surface of the reactor.

As a result of further studies on the furnace structure of the combustion section, the present inventors also have found that by adopting a furnace structure in which an air feed port or ports and a fuel feed port or ports are provided in the furnace (reactor) independently spaced-apart from each other and opened into the furnace in the same direction, and by improving the in-furnace direct fuel injection method in which combustion air and fuel are injected into the furnace independently from the said air feed port(s) and fuel feed port(s), respectively, it is possible to induce high-temperature air combustion in the furnace without using change-over type regenerative burners. The present inventors further have found that it is possible to control the combustion condition by using a structure in which an additional fuel feed port is provided in each said air feed port, and by controlling the ratio of the fuel supplied from the said fuel feed port(s) to the fuel supplied from the said additional fuel feed port(s) in the air feed port(s).

The furnace combustion apparatus and method of the present invention combine advantages of both the high-temperature air combustion method and the furnace direct fuel injection method, and realize so-called high-temperature air combustion in which combustion is effected only by the independent supply of air and fuel into the furnace without using any change-over type device such as regenerative burners, and air temperature is made higher than the self ignition temperature of fuel and also oxygen concentration is lowered before combustion air is joined with fuel. The essential points of the above-said apparatus and method are as described in (5) to (8) below.

(5) A furnace combustion apparatus characterized in that: a fuel feed port or ports and an oxygen-containing gas feed port or ports are provided independently spaced-apart from each other and opened into the furnace (reactor) on the same side thereof; (i) the shape of the oxygen-containing gas feed port(s) is non-circular or (ii) the opening diameter (DL) of the oxygen-containing gas feed port(s) and the shortest distance (Dw) between the oxygen-containing gas feed port and the inner wall of the reactor have the relation of Dw<1.5 DL; fuel and oxygen-containing gas are supplied continuously, and the distance from the crossing point of the center line of fuel flow supplied from fuel feed port and the center line of oxygen-containing gas flow supplied from oxygen-containing gas feed port to the end of oxygen-containing gas feed port is not less than twice the opening diameter of oxygen-containing gas feed port.

(6) A furnace combustion method comprising using the above-described furnace combustion apparatus.

(7) A furnace combustion method comprising using a furnace combustion apparatus in which a fuel feed port or ports and an oxygen-containing gas feed port or ports are provided independently spaced-apart from each other and opened into the furnace from the same side thereof; fuel and oxygen-containing gas are supplied continuously; and the distance from the crossing point of the center line of the fuel flow supplied from the fuel feed port and the center line of the oxygen-containing gas flow supplied from the oxygen-containing gas feed port to the end of the oxygen-containing gas feed port is not less than twice the opening diameter of the oxygen-containing gas feed port,

the oxygen-containing gas flow rate being not less than 55 m/s.

(8) A furnace combustion method using a furnace combustion apparatus in which a fuel feed port or ports and an oxygen-containing gas feed port or ports are provided independently spaced-apart from each other and opened into the furnace from the same side thereof; fuel and oxygen-containing gas are supplied continuously; and the distance from the crossing point of the center line of the fuel flow supplied from the fuel feed port and the center line of the oxygen-containing gas flow supplied from the oxygen-containing gas feed port to the end of the oxygen-containing gas feed port is not less than twice the opening diameter of the oxygen-containing feed port,

the average combustion temperature being not lower than 1,600° C.

The present invention is described in detail below. First, the apparatus and the method for producing carbon black according to the present invention are described. The carbon black producing apparatus according to the present invention is an apparatus having a first reaction zone, a second reaction zone and a third reaction zone, and is related to the so-called furnace process in which carbon black is produced by introducing a feedstock hydrocarbon.

The carbon black producing apparatus (reactor) of the present invention has arranged in the order of mentioning a first reaction zone (1) in which a combustion gas flow is formed, a second reaction zone (2) located downstream of the first reaction zone (1) in the direction of combustion gas flow formed in the said zone (1) (this direction may hereinafter be referred to as “axial direction”), in which a feedstock hydrocarbon is supplied to the formed combustion gas flow and reacted to produce carbon black, and a third reaction zone (3) located downstream of the second reaction zone and designed so that the reaction is stopped in this third reaction zone.

### First Reaction Zone

In the first reaction zone (1), generally a fuel hydrocarbon is supplied from fuel feed port(s) (5) and an oxygen-containing gas from oxygen-containing gas feed port(s) (6), and is burned to form a high-temperature combustion gas flow directed downstream of the reactor. As the oxygen-containing gas, air, oxygen gas or a mixture thereof with an inert gas such as nitrogen gas mixed at an optional rate can be used, but air is preferred for the reason of easy availability, etc. In some cases, oxygen-enriched air may be used particularly for raising the combustion temperature. Pure oxygen may be used for preventing generation of NOx particularly in high-temperature combustion. On the other hand, in order to maintain stabilized high-temperature air combustion, an additional fuel feed port may be provided in each oxygen-containing gas feed port as explained below, with part of the oxygen-containing gas being normally burned to raise oxygen-containing gas temperature while reducing oxygen concentration. As the fuel hydrocarbon, fuel gases such as hydrogen, carbon monoxide, natural gas and petroleum gas, petroleum liquid fuels such as heavy oil, and coal liquid fuels such as creosote can be used. In particular, fuel gas is preferred as the fuel hydrocarbon used in the present invention.

Fuel feed port(s) (5) and oxygen-containing gas feed port(s) (6) open into the reactor on the same side thereof and are provided independently with spacing between them. The shape of each port opened into the reactor is optional; it may be circular, elliptical, polygonal such as triangular or square, or indeterminate such as gourd-shaped. To the knowledge of the present inventors, a shape having a major diameter and a minor diameter, such as oval or oblong, is more effective than circular for expediting heating or dilution of the oxygen-containing gas. Therefore, an elliptical or roughly circular shape is preferred for fuel feed port (5) while a rectangular shape such as slit shape is preferred for oxygen-containing gas feed port (6). A combination of such shapes is more preferred.

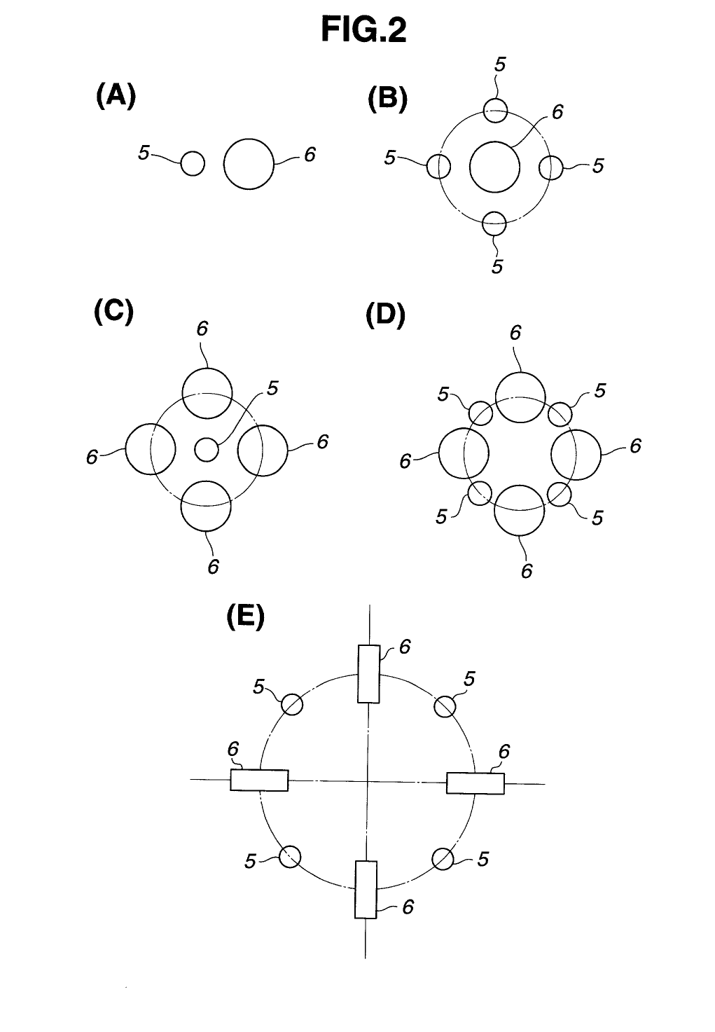

Positional arrangement of fuel feed port(s) (5) and oxygen-containing gas feed port(s) (6) is optional provided that they are disposed independently spaced-apart from each other and opened into the reactor from the same side thereof. It is possible to adopt various arrangements such as shown in FIG. 2(A) to (E) depending on the furnace design conditions such as fuel load, number of burners, etc., but it is preferred to arrange the respective feed ports alternately along the circumference of a circle sharing the same center with the cross section of the reactor in its axial direction or a concentric circle as shown in FIG. 2(D), as this arrangement is the best for uniformalizing the combustion condition in the reactor. In this case, when oxygen-containing gas feed ports (6) are of a shape having a major diameter and a minor diameter, the respective feed ports are preferably arranged so that the straight line extending from the major diameter will pass the center of the circle (see FIG. 2(E)). The opening end of each feed port may be either substantially flash with the inner wall surface of the furnace or may project therefrom, though the former is preferred.

The opening diameters Df and Da of fuel feed ports (5) and oxygen-containing gas feed ports (6) are optional, but they are decided by giving consideration to the fuel load and the number of the burners provided so that the exit flow rates of fuel and oxygen-containing gas will take the predetermined values as explained later. In case where the shape of the respective feed ports is not circular, the greatest diameter of the shape is deemed as opening diameter.

The distance between, the angles of and the flow rates at fuel feed ports (5) and oxygen-containing gas feed ports (6) are very important. By defining these elements within the ranges specified below, it is possible to meet the requirement for high-temperature air combustion that “diffusion combustion be induced by a sufficiently low-rate oxidative exothermic reaction with high-temperature dilute air whose oxygen concentration is far lower than ordinary air at least immediately before the combustion reaction and whose temperature is higher than the combustion stability limit temperature of the mixture gas at the said oxygen concentration, or with an oxidizing agent equivalent to such high-temperature dilute air.”

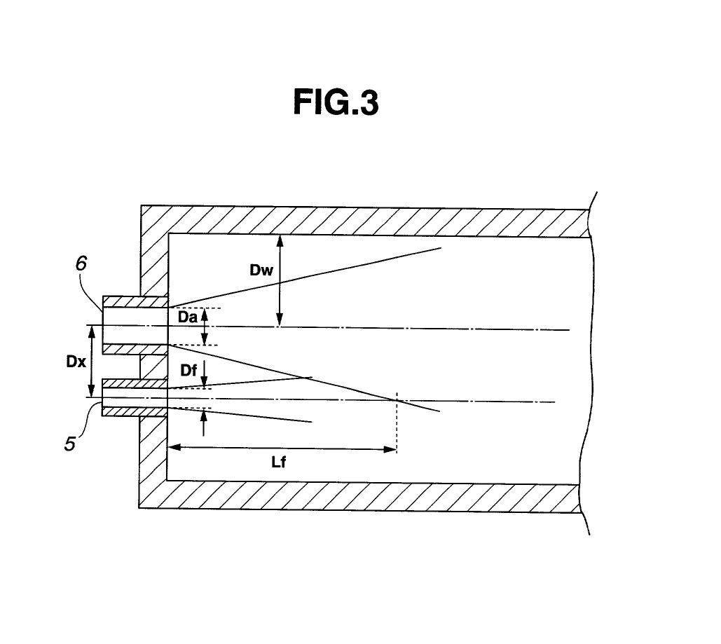

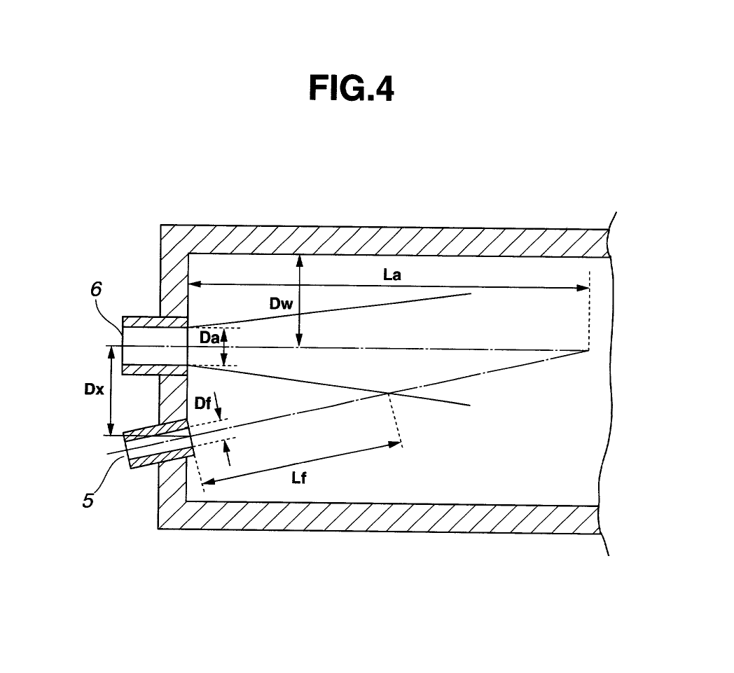

The distance Dx between fuel feed port (5) and oxygen-containing gas feed port (6) (center distance between both port openings) shown in FIGS. 3 and 4 is preferably selected to satisfy the relation of Dx≧Da. If Dx is less than the above-defined range, the time spent till the oxygen-containing gas is mixed with fuel after supplied into the reactor is too short, making it unable to meet the said requirement for high-temperature air combustion in some cases.

Oxygen-containing gas feed ports (6) are preferably arranged so that the shortest distance Dw between their opening diameter Da and the inner wall of the reactor will satisfy the relation of Dw≧1.5 Da, from the viewpoint of facilitating generation of a recirculation gas flow between the fuel gas flow and the reactor wall. However, in the case of a carbon black producing furnace using as its wall material a refractory which is lowered in strength or wear resistance in a reducing atmosphere, such as magnesia type or micromagnesia type refractory, Dw is selected to satisfy the relation of Dw<1.5 Da from the viewpoint of protecting the refractory. In this case, it is preferred that the shape of oxygen-containing gas feed ports (6) is rectangular or elliptical with the ratio of the major diameter (longer side) DL to the minor diameter (shorter side) being not less than 2:1, and that the minor diameter (shorter side) is closer to the furnace wall than the major diameter (longer side) DL, or the distance between oxygen-containing gas feed ports (6) and furnace wall is made smaller to satisfy the relation of Dw<1.5 DL, as this arrangement can provide an oxidizing atmosphere in the neighborhood of the wall surface. Such arrangement may be properly decided in consideration of various conditions such as furnace material used, combustion temperature, etc.

The fuel flow and the oxygen-containing gas flow introduced into the reactor from fuel feed ports (5) and oxygen-containing gas feed ports (6), respectively, may be supplied at any angle from the respective opening ends of the ports against the reactor wall where the feed ports are disposed, but preferably they are supplied substantially vertically to the reactor wall, or more preferably in such a manner that the supplied fuel and/or oxygen-containing gas will be diffused substantially concentrically from the center of the flow (see FIG. 3).

In the above case, it is preferred that the distance Lf taken till the fuel impinges against the oxygen-containing gas and the opening diameter Df of fuel feed ports (5) have the relation of Lf≧30 Df, particular Lf≧35 Df. By this arrangement, the supplied fuel is modified into one which is easier to burn by the combustion gas in the reactor before the fuel is joined with the oxygen-containing gas. However, if Lf is too large, combustion may fail to take place in the reactor, so that preferably Lf≦1000 Df. Here, since fuel feed ports (5) are very small and diffusion of the fuel flow is negligible as compared with diffusion of the oxygen-containing gas, Lf may be represented by the distance along the fuel flow center line. The range in which the oxygen-containing gas exists at the time of collision with the fuel is the area where the flow rate in the direction of the center axis becomes 5% of the flow rate at the center axis in a plane vertical to the center line of the jet of oxygen-containing gas.

In case where the fuel flow and the oxygen-containing gas flow are brought into contact and mixed in the reactor, it is preferred that the distance La from the crossing point of the center lines of the respective flows to the end of oxygen-containing gas feed port (6) and the opening diameter Da of oxygen-containing feed port (6) have the relation of La≧2 Da, particularly La≧3 Da (see FIG. 4). This arrangement makes it possible to meet the requirement for high-temperature air combustion that the gas mixture be “diffused and burned under a sufficiently low-rate oxidative exothermic reaction with high-temperature dilute air whose oxygen concentration is far lower than normal air at least immediately before the combustion reaction and whose temperature is higher than the combustion stability limit temperature of the gas mixture at the said oxygen concentration, or with an oxidizing agent equivalent to such high-temperature dilute air.” However, if Lf is too large, combustion may fail to take place in the reactor, so that preferably La≦10 Da.

It is possible to provide an additional fuel feed port (5) in each oxygen-containing gas feed port (6) as far as the requirements of the present invention are met. When the reactor is started under a condition where sufficient high-temperature air combustion does not occur because of low temperature in the reactor, or when it is preferred to control combustion temperature in the reactor even at a high temperature, fuel is supplied from the additional fuel feed port (5) disposed in each oxygen-containing gas feed port (6) to locally induce normal combustion, not high-temperature air combustion, to control the combustion condition in the reactor, thus allowing execution of the stable operation.

The flow rates of the oxygen-containing gas and fuel supplied into the reactor may be properly selected and adjusted according to temperature change and other factors in the reactor, but from the viewpoint of modification of combustion by reactor gas and high-temperature air combustion, the fuel flow rate is preferably set at 80 to 200 m/s while the oxygen-containing gas flow rate is usually set at 30 to 200 m/s, preferably 55 to 150 m/s. Also important is combustion temperature in the reactor, which temperature is preferably not lower than 1,600° C., more preferably not lower than 1,800° C., particularly not lower than 2,000° C. Such high-temperature combustion may pose the problem of heat resistance in the case of certain materials such as alumina refractory which is commonly used in the art. In such a case, it is suggested to construct the reactor with a material of high refractoriness such as magnesia type refractory or micromagnesia type refractory.

By supplying fuel and oxygen-containing gas into the reactor under the above conditions, it is possible to produce a state of high-temperature air combustion in the reactor according to the in-furnace direct fuel injection method. In high-temperature air combustion, it is necessary to create a condition in which furnace exhaust gas is entrained by the oxygen-containing gas and the oxygen-containing gas temperature becomes higher than the self ignition temperature of the fuel, with the oxygen concentration being kept sufficiently low (not higher than around 5%), before the oxygen-containing gas is brought into contact with at least the fuel in the reactor. Here, there are available no direct means for determining the actual oxygen concentration and temperature of the oxygen-containing gas immediately before the combustion reaction, but they can be confirmed by such means as numerical simulation using a computer.

Whether high-temperature air combustion has actually occurred or not can be confirmed by the formation of greenish flames as a result of sharp increase of the ratio of the combustion reaction intermediate product of the fuel hydrocarbon generating a green-colored luminescent spectral component in the flames to the combustion reaction intermediate product of the blue-colored luminescent spectral component, and consequent dominant appearance of such green-colored spectral component in the visible luminescent colors. In such a case, it may be supposed that the prescribed dilute air with a far lower oxygen concentration than normal air at least immediately before the combustion reaction and heated to a temperature above the combustion stability limit temperature at the said oxygen concentration and fuel are mixed and diffused to induce diffusion combustion (high-temperature air combustion) under a sufficiently low-rate oxidative exothermic reaction.

Average temperature in the first reaction zone in the production process of carbon black may be properly adjusted depending on the type of carbon black to be obtained, but it is preferably not lower than 1800° C., more preferably not lower than 2000° C. This is because the carbon black productivity enhances proportionally to the rise of combustion gas temperature. As for the upper limit of zone temperature, though the higher the better, it is decided by taking into account heat resistance of the reactor material.

Also, by defining the difference in combustion temperature between the central area and the exit area of the first reaction zone, where the combustion reaction proceeds most briskly, to be not less than 200° C., particularly not less than 100° C., to conduct combustion at a temperature approximate to the highest working temperature of the reactor wall while narrowing the temperature distribution in the reactor, it is possible to minimize damage to the reactor wall refractory in the combustion section while elevating the temperature at the feedstock hydrocarbon supply position to the highest possible level, and to suppress discharge of NOx, thus allowing efficient production of carbon black. For attaining this, the combustion gas flow formed in the first reaction zone is preferably formed by high-temperature air combustion. Such high-temperature air combustion can be effected by conducting the operation using the apparatus of the present invention described above. By forming combustion gas by such high-temperature air combustion, it is possible to perform combustion at a high temperature with a small combustion temperature difference, such as described above, to allow efficient production of carbon black.

Since fuel feed port(s) (5) and oxygen-containing gas feed port(s) (6) are provided independently spaced-apart from each other and opened into the reactor on the same side thereof as described above, the fuel and oxygen-containing gas are brought into contact with the recirculating gas flow generated in the reactor, and mixed, diluted and heated earlier than they are contacted with each other, reacted and burned, due to their own influx momentum into the reactor. By this dilution, the oxygen-containing gas is lowered in oxygen concentration and heated to a temperature above the self ignition temperature of fuel earlier than contacted with fuel, making it possible to induce high-temperature air combustion in the reactor. Consequently, only the peak temperature of combustion is lowered, non-uniformity of temperature in combustion is inhibited, and the deviation of temperature distribution in the whole first reaction zone is minimized. At the same time, it becomes possible to conduct combustion in a stable way and to avoid unstabilization of combustion due to the drop of oxygen concentration, making it possible to efficiently produce carbon black of stabilized quality

### Second Reaction Zone

In the second reaction zone, a feedstock hydrocarbon is supplied to the combustion gas flow formed in the first reaction zone from a feedstock hydrocarbon feed port (nozzle), and this feedstock hydrocarbon is primarily subjected to a pyrolytic reaction to produce carbon black.

It is considered that in the second reaction zone, carbon black is produced generally through the following process. That is, the feedstock hydrocarbon supplied into the reactor is first gasified, then pyrolyzed and carbonized into carbon black. In this operation, the combustion gas flow rate in the second reaction zone in the reactor is regulated to be 100 to 600 m/s according to the sectional area of the reactor, and the liquid feedstock hydrocarbon supplied into the reactor by spraying or other means is atomized by dint of the motion and heat energy of the gas flow, and by availing of the mixing effect produced by turbulence of gas flow formed at a choke (4), the heat energy of combustion gas is efficiently utilized for the carbon black producing reaction. After the feedstock hydrocarbon has been contacted with combustion gas flow and pyrolyzed, the carbon black is condensed into liquid droplets and formed into a precursor which becomes the nucleus, thus forming the primary particles. It is considered that thereafter, these primary particles impinge against each other and are fused together and carbonized.

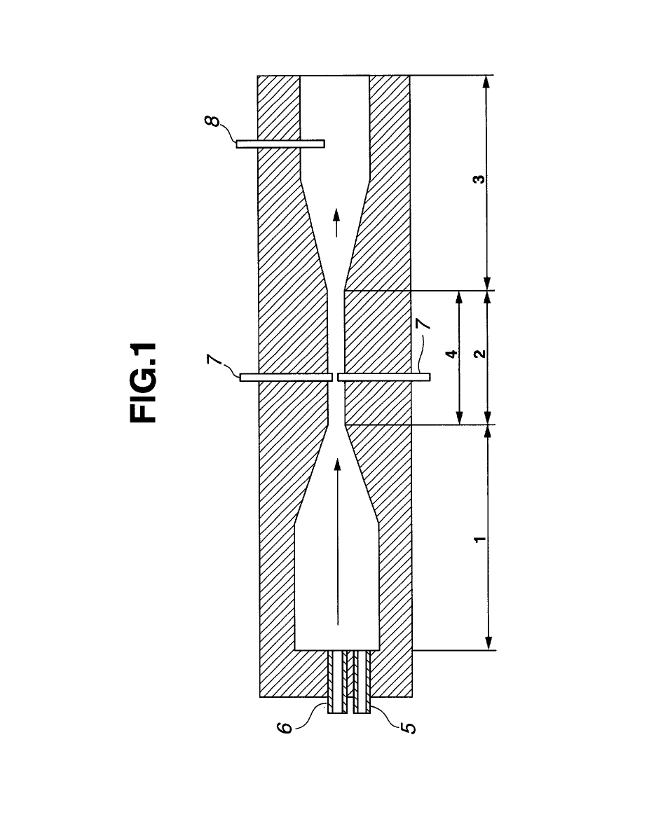

The length of the second reaction zone may be properly selected depending on the size of the reactor, the type of carbon black to be produced, and other factors. The configuration of the second reaction zone is optional; it may be of the same dimensions as the first reaction zone, but generally the reactor is of a structure in which the diameter tapers off in the direction of advance of combustion gas flow as shown in FIG. 1, forming a construction, or choke (4), before the diameter is enlarged in the third reaction zone as described later.

The length of choke (4) may be properly selected depending on the desired particle size of carbon black to be produced, etc. Generally, a larger opening diameter and a longer choke are required for obtaining carbon black of a larger particle size. In the case of ordinary carbon black of small particle size (12 to 13 nm), a choke length of not less than 500 mm is enough. In the case of carbon black of around 20 nm in particle size, the choke length should be not less than 700 mm at shortest, preferably 500 to 3,000 mm. By defining the choke length within the above-defined range, it is possible to reduce particularly the content of large agglomerates which are not less than 1.3 times the center diameter in the obtained carbon black. Since no specific effect can be obtained even if the choke length is made larger than 3,000 mm, it is usually suggested not to make it larger than 3,000 mm for the economy in construction of the apparatus.

The length of choke (4) is preferably set to be not less than 400 mm. This makes it possible to particularly reduce the large agglomerate content in the obtained carbon black. The reason therefor is that it is considered that during the period from spraying of feedstock hydrocarbon till formation of carbon black, the process remains free of the influence by turbulence of the flow caused by the change of sectional shape of the flow passage. The specific length of choke (4) and the distance from feedstock hydrocarbon feed port to the exit of choke (4) may be properly selected depending on the desired properties of the produced carbon black, etc.

The lower the degree of smoothness of the inside of the choke, the more facilitated the obtainment of carbon black having a preferable range of agglomerate distribution. Smoothness (ε) of the choke inner wall is preferably not more than 1 mm, more preferably not more than 0.3 mm. ε is an index of smoothness of the choke inner wall, and is generally referred to as “equivalent sand roughness” (Mechanical Engineering Handbook, new ed. A5, Fluid Engineering, Chap. 11 Flow in Fluid Passage, 11·2 Coefficient of Friction of Straight Pipes). This equivalent sand roughness is a value defined for determining the pipe friction coefficient in a flow in a pipe, and indicates the roughness of the pipe inner wall by specifying it in terms of sand grain size. The equivalent sand roughness of various types of practical pipes has been determined by the Japan Machinery Association (Technical Data Fluid Resistance of Pipe Lines and Ducts, 1979, 32, Japan Machinery Association). As the smooth materials with ε of not more than 1 mm, various types of metals such as stainless steel, copper, etc., can be cited as representative examples. However, in case of using a metal, since the temperature of the internal combustion gas may become higher than the endurable temperature of the metal, it is necessary to offer cooling from the outside by adopting a suitable structure such as water cooling jacket. As other materials than metals, SiC, diamond, aluminum nitride, silicon nitride, ceramic refractory materials, etc., can be exemplified.

Average temperature of the second reaction zone may be properly selected according to the type of carbon black to be produced, but the said reaction zone is preferably in a sufficiently high-temperature atmosphere for allowing uniform gasification and pyrolysis of the feedstock hydrocarbon, so that the average temperature is preferably 1,600 to 1,800° C. or higher, more preferably 1,700 to 2,400° C.

In the second reaction zone, it is preferred to minimize oxygen concentration in the combustion gas. This is because the presence of oxygen in the combustion gas may initiate partial combustion of feedstock hydrocarbon in the reaction zone, i.e. second reaction zone, causing non-uniformity in the reaction zone. Oxygen concentration in the combustion gas is preferably not more than 3 vol %, more preferably 0.05 to 1 vol %.

In the present invention, feedstock hydrocarbon can be supplied from any position between the first and third reaction zones. For example, feedstock hydrocarbon feed port (7) may be provided at a constricted part of the reactor, or it may be provided in choke (4). A combination of such arrangements is also possible. The gas flow rate and strength of turbulence at the feedstock hydrocarbon introduced position can be controlled by adjusting the position of the feedstock hydrocarbon feed port. For instance, when the feedstock hydrocarbon feed port is set close to the inlet portion of choke (4), feedstock hydrocarbon is supplied to the position where the strength of turbulence and its mixing effect is maximized, allowing the carbon black producing reaction to proceed uniformly and rapidly, so that this arrangement is suited for producing carbon black with a narrow distribution of small particle and agglomerate size.

As the feedstock hydrocarbon, it is possible to use any of those known in the art, for example, aromatic hydrocarbons such as benzene, toluene, xylene, naphthalene and anthracene, coal hydrocarbons such as creosote oil and carboxylic acid oil, petroleum heavy oils such as ethylene heavy end oil and FCC oil (fluid catalytic cracking residue oil), acetylenic unsaturated hydrocarbons, ethylenic hydrocarbons, and aliphatic saturated hydrocarbons such as pentane and hexane. These hydrocarbons may be used either independently or by mixing them at suitable proportions.

As for the position of the feedstock hydrocarbon feed port in the reactor, such feed port may be provided in plurality along the circumference of the circular section of the reactor in the flowing direction of combustion gas, or the portions having a plurality of such feedstock hydrocarbon feed ports on the circumference of a same circle may be provided in plurality in the reactor in the flowing direction of combustion gas. For uniformalizing the carbon black producing reaction time to obtain carbon black with a restricted distribution of particle and agglomerate size, it is preferred to provide as many feedstock hydrocarbon feed ports as possible on the circumference of a same circle.

The type of the nozzle used for the feedstock hydrocarbon feed port can be optionally selected, but for atomizing the feedstock hydrocarbon more uniformly and finely to obtain carbon black of small particle size, it is preferred to use a nozzle of the type in which the initial liquid droplet diameter of feedstock hydrocarbon immediately after sprayed from the nozzle is as small as it can be, for example a two-fluid nozzle by which the supplied liquid is injected together with another fluid.

The feedstock hydrocarbon feed conditions such as opening diameter and shape of the feed ports, their degree of projection into the reactor, angle of feed into the combustion gas flow, gas/liquid ratio, flowing speed, flow rate, temperature, etc., may be properly selected, but spraying is preferably conducted under such a condition that the feedstock hydrocarbon sprayed into the second reaction zone will not be deposited on the reactor wall before it is evaporated. By conducting spray in such a manner, it is possible to reduce foreign matter in carbon black.

### Third Reaction Zone

In the third reaction zone, the combustion gas flow containing carbon black (including one in the course of reaction) is cooled to 1,000° C. or below, preferably 800° C. or below. Cooling is effected by spraying water or the like from a reaction stopping fluid feed port (nozzle) (8). Cooled carbon black is separated from gas by a collecting bag filter or like means (not shown) provided at the end of the third reaction zone, and then recovered. A known ordinary process such as filtration by the said bag filter can be used for the collection of carbon black.

The third reaction zone is usually enlarged in diameter as compared to the second reaction zone. The degree of diametral enlargement in the direction of combustion gas flow is optional; the reactor diameter may be enlarged sharply or gently, but gentle enlargement is preferred for suppressing turbulence of the rapid gas flow in the enlarged portion.

Now, the furnace combustion apparatus and the furnace combustion method according to the present invention are explained. FIG. 4 is a partial sectional illustration of an example of furnace combustion apparatus of the present invention. The furnace combustion apparatus according to the present invention is characterized in that: the fuel feed port(s) and the oxygen-containing gas feed port(s) are provided independently spaced-apart from each other and opened in the reactor from the same side thereof; (i) the shape of the oxygen-containing gas feed port is non-circular or (ii) the relation between the opening diameter (DL, indicated by Da in FIG. 4) of the oxygen-containing gas feed port and the shortest distance (Dw) between the oxygen-containing gas feed port and the reactor inner wall is represented by Dw<1.5 DL; fuel and oxygen-containing gas are supplied continuously; and the distance from the crossing point of the center line of the fuel flow supplied from the fuel feed port and the center line of the oxygen-containing gas flow supplied from the oxygen-containing gas feed port to the end of the oxygen-containing gas feed port is at least twice the opening diameter of the oxygen-containing feed port. Thus, the furnace combustion apparatus and the furnace combustion method according to the present invention are the same as the carbon black producing apparatus and method described above based on FIG. 4.

According to the furnace combustion apparatus and furnace combustion method of the present invention, as described above, the supplied oxygen-containing gas and fuel are brought into contact with the recirculating gas flow in the reactor earlier than they being contacted and reacted with each other and burned, by virtue of the their own momentum of influx into the reactor, and thereby mixed, diluted and heated. By this dilution, the oxygen-containing gas is lowered in oxygen concentration and heated to a temperature higher than the self ignition point of the fuel before contacted with the fuel, thus inducing air combustion in the reactor. Thereby only the peak temperature of combustion is lowered and temperature nonuniformity during combustion is suppressed. Consequently, it becomes possible to minimize the NOx discharge level, too.

### Best Mode for Carrying out the Invention

Hereinafter, the invention is described with reference to the examples thereof, but the present invention is not limited to these examples. In the following Examples, it was tried to produce the commercial carbon black “#48” and “#960” manufactured by Mitsubishi Chemical Corporation and the representative examples of furnace carbon black. The methods of property determination and evaluation tests of the obtained carbon blacks are as described below.

(1) Specific Surface Area (N₂SA)

Determined according to ASTM D3037-88.

(2) DBP Oil Absorption (DBP)

Determined according to JIS K-6221A method.

(3) Maximum Frequency Stokes' Equivalent Diameter (Dmod) and Stokes' Equivalent Diameter Half-value Width (D½)

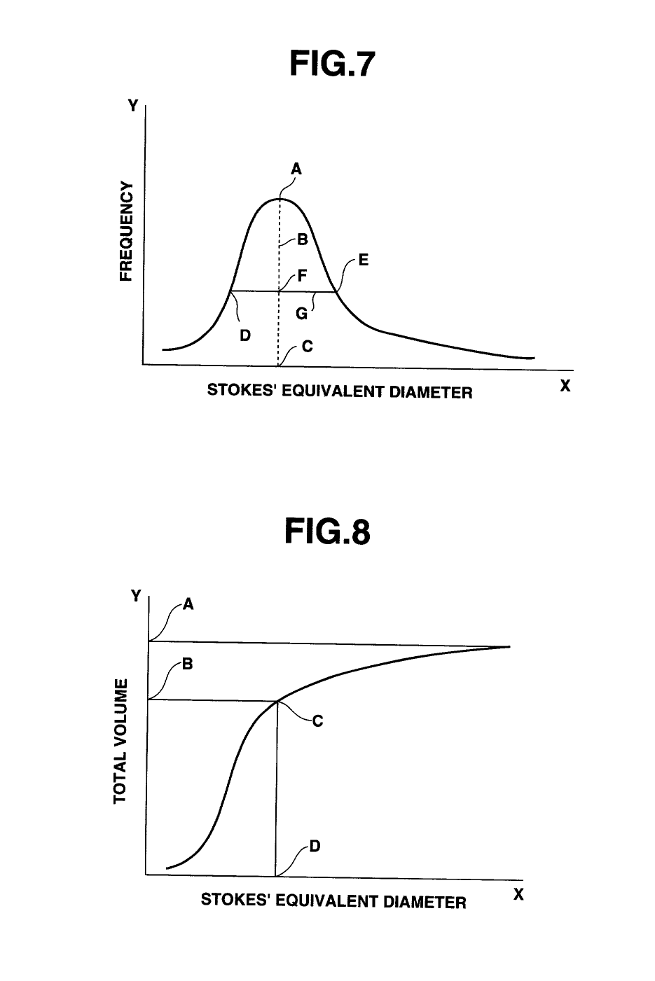

They were determined in the following way. First, using a 20 wt % ethanol solution as spinning solution, the stokes equivalent diameter was measured by a centrifugal precipitation type particle size distribution meter (Model DCF3 mfd. by JL Automation Co., Ltd.), and a histogram of relative formation frequency in a given sample versus Stokes' equivalent diameter was drawn up (see FIG. 7). Then, from the peak (A) of the histogram, a line (B) was drawn parallel to the Y axis toward the X axis, ending the line at the point (C) on the X axis. The Stokes' diameter at the point (C) is the maximum frequency Stokes' equivalent diameter, Dmod. The middle point (F) of the obtained line (B) was decided, and a line (G) was drawn passing this middle point (F) and parallel to the X axis. Line (G) intersects the distribution curve of the histogram at two points D and E. The absolute value of the difference between the two Stokes' diameters at points D and E of the carbon black particles is the Stokes' equivalent diameter half-value width, D½.

(4) 75%-volume Diameter (D75)

This was determined in the following way. In the above-described method of determining the maximum frequency Stokes' equivalent diameter, the volume of the sample was determined from the Stokes' diameter and frequency in the histogram (FIG. 7) of relative formation frequency of the sample versus Stokes' equivalent diameter, and a graph showing the total volume of the obtained samples versus Stokes' diameter was drawn up (see FIG. 8). In FIG. 8, point (A) indicates the total volume of the samples. Here, point (B) indicating the value of 75% of the total volume was decided, and a line was drawn from this point (B) parallel to the X axis until it intersected the curve. Further, a line was drawn from the point (C) parallel to the Y axis. The value at the point (D) where the line intersects the X axis is the 75%-volume diameter (D75).

(5) PVC Blackness

This was determined in the following way. Carbon black was added to a PVC resin and dispersed by a two-roll mill, and then the mixture was molded into a sheet. Blackness of each sample was rated by visual observation, with blackness of Mitsubishi Chemical Corporation's carbon blacks “#40” and “#45” being supposed to be 1 and 10, respectively, as reference.

(6) Productivity

This can be represented by the value of (amount of feedstock supplied)×(feedstock oil yield)/(amount of air). The higher the overall carbon yield is, the lower the fuel consumption rate becomes.

### EXAMPLES 1 AND 2

A carbon black producing furnace of the structure shown in FIG. 1 was used. The first reaction zone (1) is provided with a combustion burner having fuel feed ports (5) and oxygen-containing gas feed ports (6). This first reaction zone (1) is 3,370 mm long (equal inner diameter portion: 1,900 mm; tapering inner diameter portion: 1,470 mm), and the inner diameter of the equal inner diameter portion is 1,042 mm. The second reaction zone (2) is provided with a choke (4) and plural feedstock hydrocarbon feed ports (nozzles) (7), and measures 1,000 mm long and 130 mm in inner diameter. The third reaction zone has a reaction stopping fluid feed port (8) designed to function as a quenching means. This zone is 3,000 mm long (enlarging inner diameter portion: 1,500 mm; equal inner diameter portion: 1,500 mm), and the inner diameter of the equal inner diameter portion is 400 mm. A magnesia-based refractory (composition: MgO, 99.4 wt %; Fe₂O₃, not more than 0.1 wt %; Al₂O₃, not more than 0.1 wt %; SiO₂, not more than 0.1 wt %) was used as the furnace material in the first reaction zone which is exposed to high temperature.

In the first reaction zone (1), 6 fuel feed ports (5) and the same number of oxygen-containing gas feed ports (6) were set equally at the furnace bottom. The shape of fuel feed ports (5) was circular while the shape of oxygen-containing gas feed ports (6) was rectangular with the longer side measuring 149 mm and the shorter side 21 mm. Said ports (6) were so arranged that their major diameters would all be directed to the center axis of the furnace. Fuel feed ports (5) were disposed on a circle with a radius of 375.3 mm centered by the center axis of the furnace while oxygen-containing gas feed ports (6) were disposed on a concentric circle with a radius of 325 mm, with the fuel feed ports (5) being positioned slightly outside of the oxygen-containing gas feed ports (6). A fuel supply nozzle (not shown) for heating is disposed in each of the oxygen-containing gas feed ports (6). The dimensional indications shown in FIGS. 3 and 4 regarding this furnace are as explained below.

TABLE 1

| | | |
|---|---|---|
| Opening diameter Df of fuel feed port (5) | 7.9 | mm |
| Opening diameter Da of oxygen-containing | 149 | mm |
| gas feed port (6) | | |
| Distance between fuel feed port (5) and oxygen- | 187.6 | mm |
| containing gas feed port (6) (center distance | | |
| between both ports) | | |
| Major diameter DL of oxygen-containing gas | 149 | mm |
| feed port (6) | | |
| Shortest distance Dw between oxygen-containing | 196 | mm |
| gas feed port (6) and inner wall of the reactor | | |
| Distance La from the crossing point of center | 464 | mm |
| lines of fuel flow and oxygen-containing gas flow | | |
| to the end of oxygen-containing gas feed port (6) | | |
| Distance Lf needed till fuel impinges against | 329 | mm |
| oxygen-containing gas | | |

| | |
|---|---|
| Relation between Dx and Da | Dx = 1.26 Da |
| Relation between Dw and DL | Dw = 1.32 DL |
| Relation between Lf and Df | Lf = 41.6 Df |
| Relation between La and Da | La = 3.11 D |

Using the above-described furnace and also using natural gas as fuel, air as oxygen-containing gas and creosote oil as feedstock hydrocarbon, carbon blacks were produced under the conditions shown in Table 3 explained later. The properties of the obtained carbon blacks and the results of evaluation are shown in Table 4 explained later.

### COMPARATIVE EXAMPLES 1 AND 2

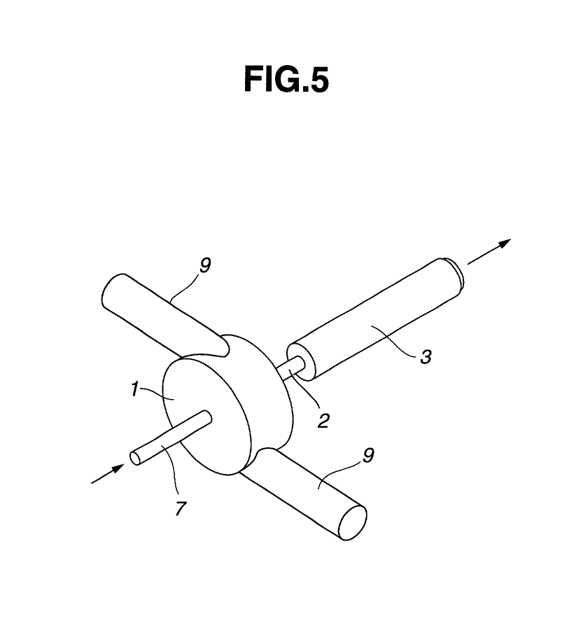

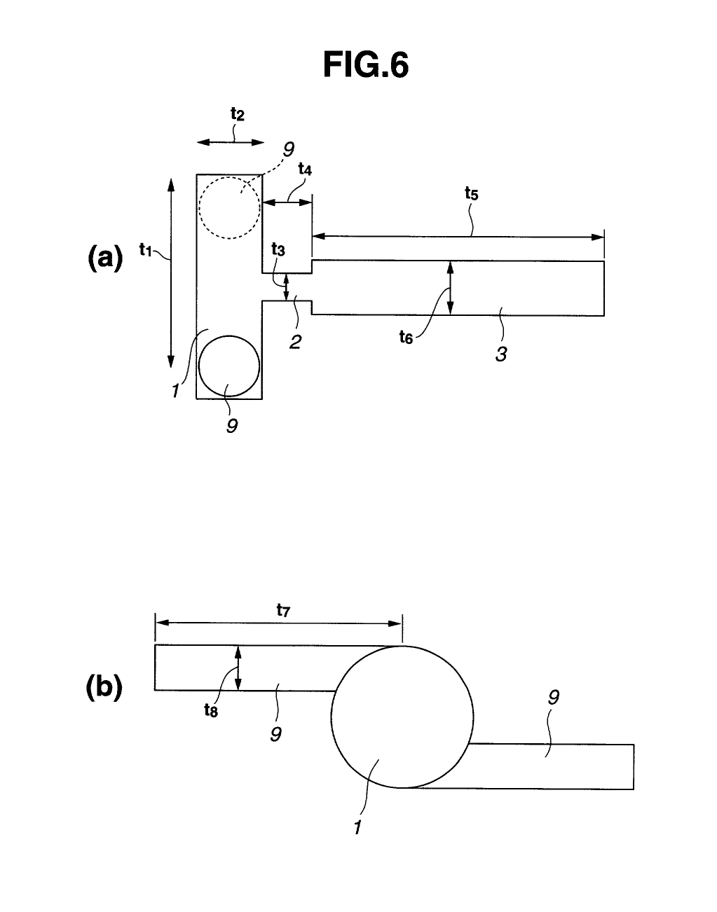

Using a conventional carbon black producing furnace shown in FIGS. 5 and 6 and also using natural gas as fuel, air as oxygen-containing gas and creosote oil as feedstock hydrocarbon, carbon blacks having the properties equal to those of the above Examples were produced under the conditions shown in Table 3 given below. The properties of the obtained carbon blacks and the results of evaluation are shown in Table 4 given below.

In the conventional furnace shown in FIG. 5, two blast tunnels (9) are connected tangentially to the first reaction zone (1), and the second reaction zone (2) having a choke and the third reaction zone (3) for stopping the reaction are joined successively downstream of the first reaction zone (1). At the end of each blast tunnel (9) is provided a combustion burner (not shown) for forming high-temperature combustion gas. This combustion burner is of the ordinary type comprising a fuel feed nozzle and an oxygen-containing gas feed nozzle. The dimensions (unit: mm) of the respective elements shown in FIG. 6 are as specified below.

TABLE 2

| | Comp. Example 1 | Comp. Example 2 |
|---|---|---|
| t1 | 1233 | 930 |
| t2 | 370 | 300 |
| t3 | 180 | 150 |
| t4 | 300 | 245 |
| t5 | 3100 | 2450 |
| t6 | 410 | 366 |
| t7 | 2450 | 2060 |
| t8 | 370 | 300 |

TABLE 3

| | | | Comp. | Comp. |
|---|---|---|---|---|
| | Ex 1 | Ex 2 | Ex. 1 | Ex. 2 |
| Unit | (#48) | (#960) | (#48) | (#960) |

| | | | | | |
|---|---|---|---|---|---|
| Amount of fuel | Nm³/H | 271 | 271 | 346 | 338 |
| supplied | | | | | |
| Amount of air | Nm³/H | 3000 | 300 | 4500 | 4400 |
| supplied | | | | | |
| Air preheating | ° C. | 400 | 400 | 400 | 400 |
| temperature | | | | | |
| Adiabatic | ° C. | 2332 | 2332 | 2066 | 2065 |
| theoretical | | | | | |
| combustion | | | | | |
| temperature | | | | | |
| Air flow rate | m/s | 75 | 75 | — | — |
| Oxygen concentration | % | 0.9 | 0.9 | 3.67 | 3.68 |
| in oxygen-containing gas | | | | | |
| Combustion gas | Nm³/H | 3291 | 3291 | 4871 | 4762 |
| Amount of feedstock | Kg/H | 680 | 400 | 1040 | 750 |
| supplied | | | | | |
| Internal pressure of | Kg/cm² | 0.45 | 0.45 | 0.26 | 0.26 |
| furnace | | | | | |
| Potassium | ppm | 539 | 315 | 150 | 200 |
| concentration | | | | | |

TABLE 4

| | | | | Comp. | Comp. |
|---|---|---|---|---|---|
| | | Ex 1 | Ex. 2 | Ex. 1 | Ex. 2 |
| | Unit | (#48) | (#960) | (#48) | (#960) |
| N₂SA | m²/g | 98.9 | 240.6 | 99.5 | 250 |
| DBP | cc/100 g | 59 | 68 | 66 | 71 |
| D1/2 | nm | 44 | 33 | 63 | 52 |
| D75 | nm | 89 | 52 | 400 | 85 |
| Dmod | nm | 60 | 39 | 70 | 45 |
| (D1/2)Dmod | | 0.73 | 0.85 | 0.9 | 1.16 |
| D75/Dmod | | 1.48 | 1.33 | 5.71 | 1.89 |
| Feedstock oil yield | % | 64.0 | 58.4 | 57.3 | 35.2 |
| Overall carbon yield | % | 55.4 | 42.7 | 51.4 | 29.7 |
| Productivity | Kg/Nm³ | 0.145 | 0.078 | 0.132 | 0.06 |

As is apparent from the results shown in Table 4, carbon blacks of Example 1 and Comparative Example 1 are substantially equal in N₂SA and DBP, and they are equivalent to the commercial furnace black “#48” produced by Mitsubishi Chemical Corporation. Also, carbon blacks of Example 2 and Comparative Example 2 are substantially equal in N₂SA and DBP, and they are equivalent to the commercial furnace black “#960” produced by Mitsubishi Chemical Corporation.

As shown in Table 3, the carbon black producing method (Examples) of the present invention is higher in adiabatic theoretical combustion temperature than in the conventional method (Comparative Examples). In this case, however, there is produced no local high-temperature portion as in the conventional combustion furnaces using combustion burners which generate flames. Therefore, it is possible to conduct combustion while keeping the whole interior of the furnace in a condition of substantially uniform temperature distribution, so that continuous and stable operation is possible without causing damage to the inside of the furnace. According to the conventional method, on the other hand, in case where combustion is conducted at an adiabatic theoretical combustion temperature same as in the Examples, the furnace portion near the burner flames is locally elevated in temperature, causing damage to the refractory composing the furnace to make it unable to carry out continuous operation.

As shown in Table 4, the Examples are higher in feedstock oil yield, overall carbon yield and productivity than the Comparative Examples. Also, the carbon blacks of the Examples are smaller in values of (D½)/Dmod and D75/Dmod than the carbon blacks of the Comparative Examples, that is, the former are narrower in agglomerate diameter distribution of carbon black, hence smaller in ratio of the large-diameter particles than the latter. This is considered attributable to high temperature of the combustion gas at the feedstock oil introduced portion and high rate of the carbon black producing reaction. It is known that such carbon black has good dispersibility and is also enhanced in blackness.

### Industrial Applicability

As explained above, according to the present invention, there are provided an apparatus and a method for producing carbon black, according to which in efficiently producing high-quality carbon black which is small in particle size and narrow in agglomerate size distribution, the fuel is burned perfectly at as high a temperature as possible and an air ratio close to 1 with minimized discharge of NOx while inhibiting damage to the reactor wall-composing refractory in the combustion section. According to the present invention, there are also provided a furnace combustion apparatus and a furnace combustion method in which high-temperature air combustion, which is low in release of NOx and capable of providing a uniform heat flux distribution, is induced in the furnace without using any change-over type regenerative burners.

What is claimed is:

1. A carbon black producing apparatus comprising a first reaction zone where an oxygen-containing gas and fuel are supplied into the reactor and burned to form a combustion gas flow, a second reaction zone disposed downstream of the first reaction zone and having a feedstock hydrocarbon feed port or ports for supplying a feedstock hydrocarbon to the combustion gas flow for reacting said hydrocarbon to produce carbon black, and a third reaction zone disposed downstream of the second reaction zone and designed so that the reaction will stop in this third reaction zone, in the first reaction zone, the fuel feed port(s) and the oxygen-containing feed port(s) being provided independently spaced-apart from each other and being opened into the reactor from the same side thereof.

2. A carbon black producing apparatus according to claim 1 having a choke in the second reaction zone.

3. A carbon black producing apparatus according to claim 1 or 2 having an additional fuel feed port in each of the oxygen-containing gas feed ports.

4. A carbon black producing apparatus according to any one of claims 1 to 3, wherein the shape of the oxygen-containing feed port opened into the reactor is non-circular.

5. A carbon black producing apparatus according to any one of claims 1 to 4, wherein the shape of the oxygen-containing gas feed port is circular, and the opening diameter (Da) of the oxygen-containing gas feed port and the shortest distance (Dw) between the oxygen-containing gas feed port and the inner wall of the reactor have a relation of Dw<1.5 Da.

6. A carbon black producing apparatus according to any one of claims 1 to 4, wherein the shape of the oxygen-containing gas feed port is non-circular, and the opening diameter (DL) of the oxygen-containing gas feed port and the shortest distance (Dw) between the oxygen-containing gas feed port and the inner wall of the reactor have a relation of Dw<1.5 DL.

7. A carbon black producing apparatus according to any one of claims 1 to 6, wherein the distance from the crossing point of the center line of the fuel flow supplied from the fuel feed port and the center line of the oxygen-containing gas flow supplied from the oxygen-containing gas feed port to the end of the oxygen-containing gas feed port is not less than twice the opening diameter of the oxygen-containing gas feed port.

8. A method of producing carbon black comprising using a producing apparatus as defined in any one of claims 1 to 7.

9. A method of producing carbon black according to claim 8, wherein the oxygen-containing gas flow rate is not less than 55 m/s.

10. A method of producing carbon black according to claim 8 or 9, wherein the average temperature of the first reaction zone is not lower than 1,600° C.

11. A method of producing carbon black according to any one of claims 8 to 10, wherein the combustion gas flow temperature in the vicinity of the feedstock hydrocarbon feed port is not lower than 1,600° C.

12. A method of producing carbon black according to any one of claims 8 to 11, wherein the oxygen concentration in the vicinity of the feedstock hydrocarbon feed port is not more than 3%.

13. A method of producing carbon black comprising using a carbon black producing apparatus which comprises a first reaction zone where an oxygen-containing gas and fuel are supplied into the reactor and burned to form a combustion gas flow, a second reaction zone disposed downstream of the first reaction zone and having a feedstock hydrocarbon feed port or ports for supplying a feedstock hydrocarbon to the combustion gas flow for reacting said hydrocarbon to produce carbon black, and a third reaction zone disposed downstream of the second reaction zone and designed so that the reaction will stop in this third reaction zone,
in the first reaction zone, the combustion gas flow being formed by high-temperature air combustion.

14. A method of producing carbon black according to claim 13, wherein the average temperature of the first reaction zone is not lower than 1,600° C.

15. A method of producing carbon black according to claim 13 or 14, wherein the combustion gas temperature in the vicinity of the feedstock hydrocarbon feed port is not lower than 1,6° C.

16. A method of producing carbon black according to any one of claims 13 to 15, wherein the oxygen concentration in the vicinity of the feedstock hydrocarbon feed port is not more than 3%.

17. A method of producing carbon black comprising using a carbon black producing apparatus having a first reaction zone where fuel and an oxygen-containing gas are supplied into the reactor from a fuel feed port or ports and an oxygen-containing gas feed port or ports provided independently spaced-apart from each other to open into the reactor, a second reaction zone disposed downstream of the first reaction zone and having a feedstock hydrocarbon feed port or ports for supplying a feedstock hydrocarbon to the combustion gas flow for reacting said hydrocarbon to produce carbon black, and a third reaction zone disposed downstream of the second reaction zone and designed so that the reaction will stop in this third reaction zone, the average temperature of the first reaction zone is not lower than the ignition temperature of the fuel, and combustion being conducted while forming a recirculating flow between the oxygen-containing gas feed flow and the inner wall surface of the reactor.

18. A method of producing carbon black according to claim 17 wherein in the first reaction zone, the fuel feed port(s) and the oxygen-containing gas feed port(s) are provided independently spaced-apart from each other and opened into the reactor from the same side thereof.

19. A method of producing carbon black according to claim 17 or 18, wherein the reactor wall surface in the first reaction zone is under an oxidizing atmosphere.

20. A method of producing carbon black according to any one of claims 17 to 19, wherein the average temperature of the first reaction zone is not lower than 1,600° C.

21. A method of producing carbon black according to any one of claims 17 to 20, wherein the oxygen concentration in the vicinity of the feedstock hydrocarbon feed ports is not more than 3%.

22. A furnace combustion apparatus having such constitution that: a fuel feed port or ports and an oxygen-containing gas feed port or ports are provided spaced-apart from each other and opened into the furnace from the same side thereof; (i) the shape of the oxygen-containing gas feed port(s) is non-circular or (ii) the opening diameter (DL) of the oxygen-containing gas feed port(s) and the shortest distance (Dw) between the oxygen-containing gas feed port and the inner wall of the reactor have the relation of Dw<1.5 DL; fuel and oxygen-containing gas are supplied continuously; and the distance form the crossing point of the center line of the fuel flow supplied from the fuel feed port and the center line of the oxygen-containing gas flow supplied from the oxygen-containing gas feed port to the end of the oxygen-containing gas feed port is not less than twice the opening diameter of the oxygen-containing gas feed port.

23. A furnace combustion apparatus according to claim 22 having an additional fuel feed port in each of the oxygen-containing feed ports.

24. A furnace combustion apparatus according to claim 22 or 23, wherein the distance from the crossing point of the fuel flow and oxygen-containing gas flow to the end of the fuel feed port is not less than 30 times the opening diameter of the fuel feed port.

25. A furnace combustion apparatus according to any one of claims 22 to 24, wherein at least part of the furnace inner wall is made of magnesia- or micromagnesia-based refractory material.

26. A furnace combustion method comprising using a furnace combustion apparatus as defined in any one of claims 22 to 25.

27. A furnace combustion method comprising using a furnace combustion apparatus in which a fuel feed port or ports and an oxygen-containing gas feed port or ports are provided independently spaced-apart from each other and opened into the furnace from the same side thereof; fuel and oxygen-containing gas are supplied continuously; and the distance from the crossing point of the center line of the fuel flow supplied from the fuel feed port and the center line of the oxygen-containing gas flow supplied from the oxygen-containing gas feed port to the end of the oxygen-containing gas feed port is not less than twice the opening diameter of the oxygen-containing gas feed port, the oxygen-containing gas flow rate being not less than 55 m/s.

28. A furnace combustion method using a furnace combustion apparatus in which a fuel feed port or ports and an oxygen-containing gas feed port or ports are provided independently spaced-apart from each other and opened into the furnace from the same side thereof; fuel and oxygen-containing gas are supplied continuously; and the distance from the crossing point of the center line of the fuel flow supplied from the fuel feed port and the center line of the oxygen-containing gas flow supplied from the oxygen-containing gas feed port to the end of the oxygen-containing gas feed port is not less than twice the opening diameter of the oxygen-containing feed port, the average combustion temperature being not lower than 1,600° C.

29. A furnace combustion method according to any one of claims 26 to 28, wherein the inner wall surface of the combustion furnace is under an oxidizing atmosphere.
